(19) United States
(12) Patent Application Publication
(10) Pub. No.: US 2025/0246804 A1
(43) Pub. Date: Jul. 31, 2025

(54) NON-CONTACT DUAL COAXCIAL CHANNEL RF ROTARY JOINT STRUCTURE USED IN RADAR APPLICATIONS

(71) Applicant: PROFEN ILETISIM TEKNOLOJILERI VE HIZMETLERI SANAYI TICARET ANONIM SIRKETI, Istanbul (TR)

(72) Inventors: Mehmet Emin POLAT, Istanbul (TR); Ismail SISMAN, Istanbul (TR)

(21) Appl. No.: 18/775,894

(22) Filed: Jul. 17, 2024

(30) Foreign Application Priority Data
Jan. 25, 2024 (TR) 2024/000911

(51) Int. Cl. H01Q 1/50; G01S 7/03; H01P 1/06

(52) U.S. Cl. CPC H01Q 1/50; G01S 7/032; H01P 1/067

(57) ABSTRACT

Disclosed is a non-contact rotary joint structure that provides communication between the moving radar antenna and subsystems in radar applications and includes two RF channels with a gap in order to ensure that the rotating and fixed parts are non-contact.

### CROSS-REFERENCE TO RELATED APPLICATIONS

Not applicable.

### BACKGROUND OF THE INVENTION

The invention generally relates a non-contact RF rotary joint structure used in radar applications.

The invention is particularly designed with a gap structure in order to ensure that the rotating and fixed parts of the two RF channels in the rotary joint structure, which provide RF communication between the moving radar antenna and the subsystems in radar applications, are non-contact.

RF Rotary joints are used as RF transmission elements in continuously moving antenna systems. Since they are passive components, they play an active role in RF signal communication by providing bidirectional transfer of signals between two interfaces. It has different configurations, including single-channel and multi-channel, depending on the radar antenna system technology to be used.

It is used in microwave communication systems, military radar systems, satellite antenna systems and other RF applications. The non-contact structure of RF rotary joints provides a high rotation life. In this way, since there is no friction or similar physical difficulties, the renewal of the rotary joint structure is not possible in short periods. In addition, replacing the rotary joint has a negative impact in terms of time and cost.

In contact RF rotary joint techniques, RF non-contact rotary joints have been developed as a solution to the problem of lack of longevity caused by rotary joints with a limited number of rotations.

As a result of a research carried out in the state of the art, the application numbered EP0210543B1 was found. A radar rotary joint is described in said application. It has been stated that said radar rotary joint provides an efficient, high-performance and low-cost rotating connection for the radar system. In order to achieve this, it comprises a first circular waveguide, a second circular waveguide and a transition means that functionally connects the second circular waveguide to the first circular waveguide. As described here, an efficient connection can be provided in radar systems, but it has not been described as having a long-lasting structure. As it is not long-lasting, changing the rotary joint has a negative impact in terms of time and cost, as in the other rotary joints in the present technique.

As a result, developments are made in rotary joint structures, therefore new structures are required, which will eliminate the disadvantages mentioned above and provide solutions to existing systems.

### SUMMARY OF THE INVENTION

The present invention relates to a non-contact RF rotary joint structure that meets the above-mentioned requirements, eliminates all disadvantages and brings some additional advantages.

The main aim of the invention is to provide a non-contact rotary joint structure that provides RF communication between the moving radar antenna and subsystems in radar applications, and comprises two RF channels in a gap structure, with the rotating and fixed parts such that they are being non-contact.

Another object of the invention is to provide a non-contact rotary joint structure with low intervention losses by means of the conductive pins it contains.

An object of the invention is to provide long-lasting use by preventing the friction that occurs during rotation by means of its hollow structure.

Another object of the invention is to enable it to be used in different types of radar applications by means of its physically smaller, flexible and more compact structure.

Another object of the invention is to ensure that it can be used for “bistatic” radars with different transmitter and receiver antennas by means of the two separate RF channels it contains. In addition, it has a high isolation value between the two channels as it is terminated with “choke” structures that short-circuit the signal in both channels.

The structural and characteristic features and all the advantages of the invention will be understood more clearly by means of the drawings given below and the detailed description written with references to these drawings. For this reason, the evaluation needs to be made by taking these drawings and detailed description into consideration.

### BRIEF DESCRIPTION OF DRAWINGS

In order to understand the structure of the present invention and its advantages with additional elements best, it should be evaluated together with the drawings described below.

FIG. 1 is a top view of the rotary joint structure, which is the subject of the invention.

FIG. 1A is a perspective view of the rotary joint structure, which is the subject of the invention.

FIG. 2 is a sectional view of the rotary joint structure, which is the subject of the invention.

FIG. 3 is a detailed sectional view of the rotary joint structure, which is the subject of the invention.

FIG. 4 is another detailed sectional view of the rotary joint structure, which is the subject of the invention.

FIG. 5 is the view of the rotary joint structure of the invention integrated into the radar antenna shell structure.

### REFERENCE NUMBERS

1. First channel input port
2. First channel output port
3. Second channel input port
4. Second channel output port
5. First channel power divider arms
6. First channel power divider arms
7. Transmission line
8. Antenna unit
9. Pins
10. First ladder structure
11. Second ladder structure
12. Third ladder structure
13. First channel gap
14. Second channel gap
15. Common gap

### DETAILED DESCRIPTION OF THE INVENTION

In this detailed description, the preferred embodiments of the rotary joint structure of the invention are described only for a better understanding of the subject and in a way that does not form any limiting effect.

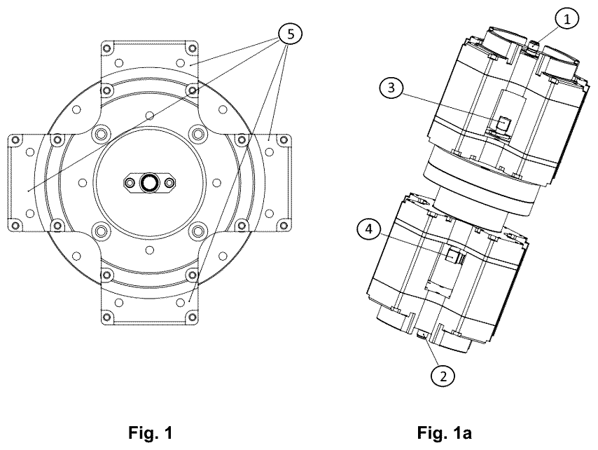

As can be seen in FIGS. 1-5, the invention is a non-contact rotary joint structure in a two-channel structure to ensure communication between the moving radar antenna and subsystems in radar applications; comprising the following:
a first channel input port (1) and a second channel input port (3) in a rotating structure that provide signal input,
a first channel output port (2) and a second channel output port (4) in a fixed structure from which the incoming signal is read,
at least one common gap (15) configured to prevent signal leakage to form a non-contact structure between the first channel input port (1) and the second channel input port (3) in the rotating structure and the first channel output port (2) and the second channel output port (4) in the fixed structure,
at least one first channel gap (13) configured so that there is no signal leakage in order to eliminate incompatibilities caused by lack of contact in said first channel,
at least one second channel gap (14) configured so that there is no signal leakage in order to eliminate incompatibilities caused by lack of contact in said second channel,
power divider arms (5, 6) comprising pins (9) located at the first input port (1) and first output port (2) of said first channel, which divide the signal radiating from the ports into four equal phase branches,
a transmission line (7) located in said second channel, which carries the second channel RF signal,
an antenna unit (8) located in said first channel, which ensures that the first channel RF signal radiates with high directivity in accordance with the waveguide,
a first ladder structure (10) and a second ladder structure (11) configured to ensure impedance and polarization matching of a signal going from said first channel input port (1) to the first channel output port (2) while passing from the main mode to the coaxial circular waveguide,
a third ladder structure (12) configured to ensure impedance and polarization matching of the signal passing from the coaxial circular waveguide to the main mode in said first channel.

In a preferred embodiment of the invention, the rotary joint structure used in bistatic radar applications enables the transmission of the RF signal between the fixed and moving parts of two RF channels, the first channel and the second channel, located in a sleeve, with minimum loss and high performance. Herein, the fixed parts comprises the first channel input port (1) and the second channel input port (3). The moving parts comprises the first channel output port (2) and the second channel output port (4).

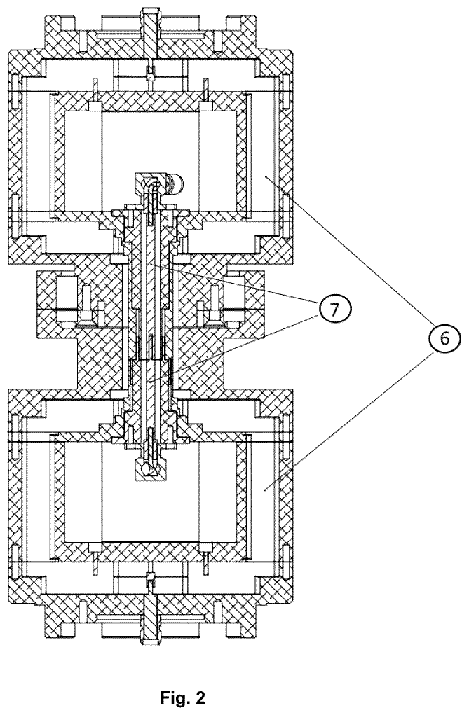

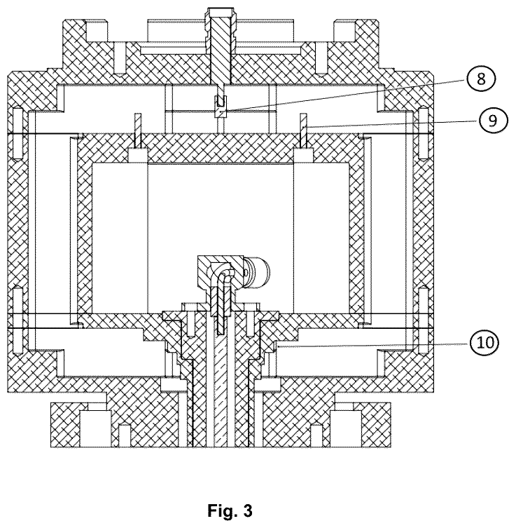

In the rotary joint structure, which is subject of the invention, there is a first channel input port (1) with high power resistance for the first channel. Herein, the main mode signal radiating from the ports is divided into four equal phases by power divider arms (5, 6). It comprises pins (9) for the in-phase progression of the signal divided into four arms by the power divider arms (5, 6). The equal-phase signal coming from four separate arms is collected again and the impedance and polarization matching of the collected signal is ensured by the first ladder structure (10). In the opposite direction, the impedance and polarization matching of the signal passing from the coaxial circular waveguide to the main mode in the first channel is provided by the third ladder structure (12). Following the ladder structure, the signal proceeds into coaxial circular waveguides. The impedance and polarization matched signal is transmitted symmetrically by proceeding in TEM mode. The signal radiates from the first channel input port (1) and the first channel output port (2) through the antenna unit (8) shown in FIG. 3, with high directivity in accordance with the waveguide. In this way, signal directionality is increased. The second channel comprises a coaxial transmission line (7) that carries the RF signal and whose dielectric material is air. In FIG. 2, it is given a sectional view of the power divider arms (5, 6) and the transmission line (7).

In the first channel and the second channel, a common gap (15) is configured between the first channel input port (1) and the second channel input port (3) in the rotating structure and the first channel output port (2) and the second channel output port (4) in the fixed structure to form a non-contact structure so that there is no signal leakage. A high operating life is obtained by designing the rotating and fixed parts of both channels to be non-contact with each other.

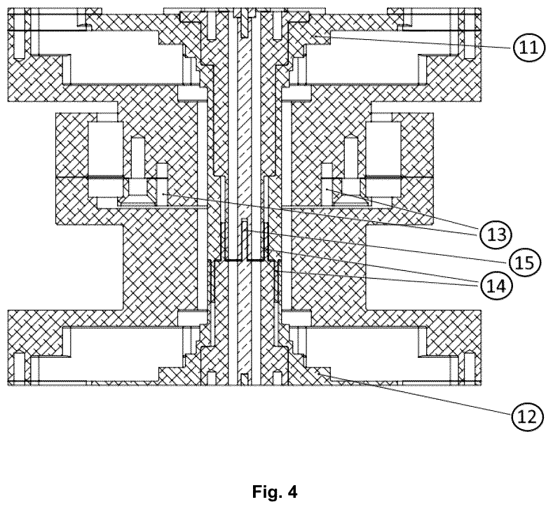

In addition, the first channel gap (13) is configured with a quarter wavelength length so that there is no signal leakage in order to eliminate the incompatibilities caused by non-contact in the first channel, and the second channel gap (14) with a quarter wavelength length is configured so that there is no signal leakage to eliminate the incompatibilities caused by non-contact in the second channel. The gap structures can be seen in FIG. 4.

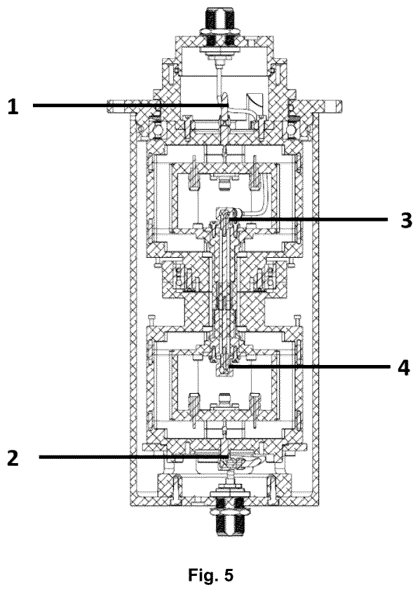

The rotary joint structure, which is subject of the invention is physically smaller and more compact than other products currently developed with high lifespan. In this way, since flexibility is provided in the locations where it will be positioned, its usability in different radar types increases. Although the rotary joint structure, which is subject of the invention has a non-contact structure, the intervention losses are obtained as lower than the existing rotary joint units. It is suitable for use in “bistatic” radars with different transmitter and receiver antennas by means of the two separate RF channels used. As seen in FIG. 5, the two-channel non-contact RF rotary joint structure with four elbow geometry is placed inside the sleeve structure to form the whole system. The structure provides rotation within the sleeve and provides RF transmission with low loss.

1. A non-contact rotary joint structure in a two-channel structure used to provide communication between a moving radar antenna and subsystems in radar applications, the non-contact rotary joint structure comprising:
a first channel input port and a second channel input port in a rotating structure that provide signal input;
a first channel output port and a second channel output port in a fixed structure from which the entering signal is read;
at least one common gap configured to prevent signal leakage to form a non-contact structure between the first channel input port and the second channel input port in the rotating structure and the first channel output port and the second channel output port in the fixed structure;
at least one first channel gap configured so that there is no signal leakage in order to eliminate incompatibilities caused by lack of contact in said first channel;
at least one second channel gap configured so that there is no signal leakage in order to eliminate incompatibilities caused by lack of contact in said second channel;
power divider arms comprising pins located at the first input port and first output port of said first channel, which divide the signal radiating from the ports into four equal phase branches;
an antenna unit located in said first channel, which ensures that the first channel RF signal radiates with high directivity in accordance with the waveguide; and
a transmission line located in said second channel, which carries the second channel RF signal.

2. A non-contact rotary joint structure according to claim 1, comprising:
a first ladder structure and a second ladder structure configured to ensure impedance and polarization matching of a signal going from said first channel input port to the first channel output port while passing from the main mode to the coaxial circular waveguide; and
a third ladder structure configured to ensure impedance and polarization matching of the signal passing from the coaxial circular waveguide to the main mode in said first channel.
